(19) United States
(12) Patent Application Publication
(10) Pub. No.: US 2008/0210129 A1
(43) Pub. Date: Sep. 4, 2008

(54) Composition Containing Organopolysiloxanes, Method for the Production thereof and Use of the Same

(75) Inventors: Sabine Nienstedt, Bonn (DE); Horst Lange, Bochum (DE); Albert Schnering, Koln (DE); Martin Kropfgans, Odenthal (DE)

Correspondence Address: NORRIS, MCLAUGHLIN & MARCUS, P.A., 875 THIRD AVE, 18TH FLOOR, NEW YORK, NY, 10022, US

(73) Assignee: GE Bayer Silicones GmbH & Co. KG, Leverkusen (DE)

(21) Appl. No.: 10/508,471

(22) PCT Filed: Mar. 19, 2003
(86) PCT No.: PCT/EP03/02862

§ 371 Date: May 9, 2005

(30) Foreign Application Priority Data
Mar. 22, 2002 (DE) 102 13 020.5

(51) Int. Cl. C04B 41/49; C07F 7/18

(52) U.S. Cl. 106/287.13; 106/287.14; 134/42

(57) ABSTRACT

Aqueous compositions comprising peroxides and polyorganopolysiloxanes useful for cleaning and disinfecting substrate surfaces.

Formulations for cleaners of hard surfaces such as ceramics, tiles, glass, plastics, enameled surfaces, metals, and floor coverings have been known for some time. A comprehensive list of the raw materials used and their effects may be found, for example, in the yearbook for practitioners (from the oil, fats, soaps, body care products, wax, and other chemical engineering industries), 22nd edition, 1979.

Hollemann-Wiberg, Lehrbuch der Anorganischen Chemie [Textbook of Inorganic Chemistry], 81-90th edition, 1976 describes, for example, the use of peroxides as a bleach and their disinfecting effect for medical and cosmetic purposes.

U.S. Pat. No. 4,005,030 describes anionic cleaning formulations for hard surfaces which contain cationic organoalkoxysilanes and surfactant. In this case, the organosilanes improve the anti-adhesive properties of the surface in relation to dirt particles.

U.S. Pat. No. 4,337,166 describes the use of a cyclic siloxane in a formulation for cleaning hard surfaces.

U.S. Pat. No. 4,689,168 describes the use of a cyclic polydimethylsiloxane in a two-phase formulation for cleaning hard surfaces.

WO 99/31212 describes a formulation for cleaning hard surfaces which contains a synergistic combination of three materials, comprising a surfactant with a wetting action (super-wetting), silicone glycol, which reduces surface tension, and an organic component having a degreasing effect.

DE 4 032 126 A1 discloses the use of hydrogen peroxide as a component of a cleaner in combination with rhubarb juice and anionic and non-ionic surfactants for hard surfaces.

U.S Pat. No. 5,962,388 describes compositions for cleaning surfaces which contain polycarboxylic acids, more than two anionic surfactants, hydrogen peroxide, a short-chain polyether, and an additional selected hydrophilic polymer.

U.S. Pat. No. 6,136,766 discloses compositions of aqueous and non-aqueous cleaners which comprise low molecular weight cyclic siloxanes and hydrophilic solvents, such as polyether polysiloxanes.

U.S. Pat. No. 4,960,533 claims the use of a polyether polysiloxane in combination with a cyclic polydimethyl siloxane and pentane dicarboxylic acid in a formulation for removing dirt residue on hard surfaces.

U.S. Pat. No. 5,439,609 claims an aqueous cleaning composition which contains a polyether polysiloxane, an alkyl ethoxylate, a glycerin ether, and chelating agents. This formulation is simultaneously to allow cleaning and prevent further contamination.

In “Silicone—Chemie und Technologie [Silicone—Chemistry and Technology]”, Vulkan-Verlag Essen, 1989 and in W. Noll, Chemie und Technologie der Silicone [Chemistry and Technology of Silicone], Verlag Chemie, Weinheim, 1968, the manufacturing, structure, and use of polyether polysiloxanes and their property of reducing surface tension are described. As a typical property of polyether polysiloxanes, after they are deposited on hard surfaces, their reduction of surface tension may lead to a reduction of the formation of lime residues, because further contamination is made more difficult and water resistance is also improved.

The cleaning compositions containing peroxide compounds which are described in the related art basically have the problem of instability of the peroxide compounds, which leads to low storage stability, particularly at elevated temperatures.

The object of the present invention is therefore to provide a cleaner containing storage-stable peroxide compounds, having an outstanding cleaning effect, in particular reduced further contamination.

Surprisingly, the inventors have found that compositions containing peroxide compounds may be stabilized by adding polyether polysiloxane compounds and the effect of the compositions in preventing further contamination may be improved simultaneously. The stabilization is especially outstanding if the polyether polysiloxanes used were subjected to a special purification method.

The present invention is based on the surprising observation that the addition of a polyether polysiloxane to an aqueous solution of hydrogen peroxide slows its auto-oxidative decomposition and, in addition, on the recognition that the decomposition of aqueous acid hydrogen peroxide solutions may be slowed if a polyether polysiloxane that is purified of metals and other trace materials which encourage peroxide decomposition is used.

The present invention thus provides a composition which may be obtained by mixing:
a) water,
b) at least one peroxide compound,
c) at least one acid,
d) at least one organopolysiloxane having at least one alkyl group, the alkyl group containing at least one ether group and/or at least one OH group,
e) optionally at least one low molecular weight siloxane, and
f) optionally at least one auxiliary material.

The component a) is water.

The water used for the component a) for manufacturing the composition includes clean tap water or preferably deionized water which was purified using a combination of an anionic and cationic standard ion exchanger. It is preferably deionized water.

As component b), the peroxide compound includes, in addition to hydrogen peroxide, any arbitrary inorganic and organic peroxides. An extensive description of inorganic peroxides, which are incorporated here, including the perborates, is found in Hollemann-Wiberg, Lehrbuch der Anorganischen Chemie [Textbook of Inorganic Chemistry], 81-90th edition, 1976. Organic peroxides are described in Morrison-Boyd, Lehrbuch der Organischen Chemie [Textbook of Organic Chemistry], second corrected edition, 1984, and are also incorporated in the present invention, including the hydroperoxides and peracids. It is possible to use mixtures of peroxide compounds. Hydrogen peroxide is especially preferred.

The content of the peroxide compound is expediently selected so that a content of active peroxide oxygen of 0.001 to 10 weight-percent, preferably 0.1 to 3, results in relation to the total weight of the composition immediately after manufacturing (<1 hour) of the mixture. The content of active peroxide oxygen relates in this case to an oxygen atom which is in the —O—O group.

The molar peroxide content expediently exceeds the molar content of other oxidizable components, auxiliary materials or byproducts present, such as oxidizable surfactants or alcohols. The content of peroxide and/or active oxygen is determined photometrically via an absorption measurement at 508 nm using a UV photo spectrometer via the formation of iron (III) thiocyanate.

It is clear to one skilled in the art in this case that new peroxo compounds may form during the manufacturing of the composition according to the present invention.

For example, peracids may form from the reaction of the peroxides with the acids of the component c). The content of active oxygen includes the total content of peroxide oxygen of the composition in this case, i.e., also the oxygen of the peroxide compounds which only form when the components are mixed.

The acid used as the component c) may include any arbitrary inorganic or organic acid, particularly a Bronsted acid. Organic acids include, for example: multibasic carboxylic acids having up to 8 carbon atoms, such as tartaric acid, malic acid, glutaric acid, as are described, for example, in U.S. Pat. No. 5,439,609, column 3, and are typical and/or permissible in cleaning compositions.

Preferably, mineral acids, such as sulfuric acid, hydrochloric acid, or phosphoric acid, or selected acids as are described, for example, in EP 336 878 p. 2, are used according to the present invention. Sulfuric acid is especially preferred.

It is possible to use multiple acids in combination.

The quantity of acid used in the composition according to the present invention is expediently selected so that a pH value from approximately 0 to 7, preferably from 0 to 6, especially preferably 0 to 5 results.

The quantity of the acid as the component c) is selected as a function of the peroxide compound used and the desired cleaning effect. In a preferred variant, the molar peroxide content does not exceed the molar content of the acid anions. The quantity of the acid used according to the present invention is therefore expediently approximately 10⁻⁷-1 mol/liter, preferably approximately 10⁻⁵-1 mol/liter of an acid, in relation to the equivalent [H⁺]. This means approximately 10⁻⁷-1 mol/liter of a monobasic acid may be used, and half of the molar quantity cited may be used for a dibasic acid. Thus, for example, approximately 5×10⁻⁷-4.8 weight-percent H₂SO₄ may be used.

The polyether polysiloxane used as the component d) according to the present invention is a compound which has at least one polysiloxane residue and at least one polyether residue.

The siloxane molecule may be constructed in principle from all siloxy units, i.e., R₃SiO_{½}, R₂SiO, RSiO _{3/2}, or SiO _{4/2} units. The polysiloxane residues may thus also have a small proportion of T and Q units. In this case, liquid siloxanes are preferred. Linear or cyclic polysiloxane residues are especially preferred. The average degrees of polymerization of the weight average M_{W} result from the below-mentioned indices r, x, and y.

The polyether polysiloxanes used according to the present invention are especially preferably at least one polyether polysiloxane which is selected from the group comprising polyether polysiloxanes of the general formulas (I), (II), and (III):

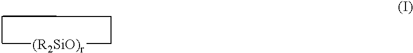

R₃SiO(R₂SiO)ₓSiR₃ (II)

[(R₃SiO_{½})₁₋₄(SiO _{4/2})]_{y} (III)

in which
r=3-10 and preferably 3 to 5,
x=0-200, preferably 1 to 100,
y=1-1000, preferably 1, i.e., [(R₃SiO_{½})₄(SiO _{4/2})]₁
   the substituents R may be identical or different and may be selected from the group comprising:
   straight-chain and branched C₁-C₁₂ alkyl, C₆-C₁₄ cycloalkyl, phenyl, phenyl alkyl, such as phenyl ethyl (styryl)-(CH₂)ₙC_{z}F_{2z+1}, in which n=1-12 and z =1-12, and an alkyl group, the alkyl group containing at least one ether group and/or at least one OH group,
   with the proviso that at least one substituent R per polysiloxane molecule represents the alkyl group cited, which contains at least one ether group and/or at least one OH group. R is preferably alkyl, especially preferably methyl. Therefore, hydroxyalkyl ether and polyether poly(dimethylsiloxane) are especially preferred.

It is preferable for this residue to be bonded to the silicon atom of the polysiloxane residue via a carbon atom.

The residue cited, which contains polyalkylene oxide units, statistically has at least one sequential alkyleneoxy unit, particularly an ethyleneoxy, propyleneoxy, and/or butyleneoxy unit. Ethyleneoxy units are especially preferred. In this case, the polyalkylene oxide units may have block copolymer or terpolymer units of the alkylene oxides cited, or they may be statistical copolymer or terpolymer units.

The polyether polysiloxanes used according to the present invention may have residues containing one or more possibly different polyalkylene oxide units.

The residue cited, which contains the polyalkylene oxide units, especially preferably represents at least one side chain on the units R₂SiO, RSiO _{3/2} of the polysiloxane residue cited, it having formally replaced a methyl group in these siloxy units.

An especially preferred residue as a substituent R in the formulas (I), (II), and (III) having polyalkylene oxide units has the formula (IV):

—Z—(CH₂CH₂O)ₐ(CH₂CH{CH₃}O)_{b}(CH₂CH₂CH₂CH₂O)_{c}X_{d}-R¹ (IV).

In this formula, Z is a straight-chain or branched alkyl or cycloalkyl residue, which each may be interrupted by —O— and/or —CO— and may possibly be substituted by at least one OH group. Z preferably has from 1 to 22 carbon atoms. These residues are a result of reactions of alkenyl alcohols, such as alkyl alcohol, alkenyl oxirane ethers, such as allyl glycide ethers, vinyl cyclohexene oxide, allyl glycosides, and alkenyl polyol partial ethers. The reactions include, for example, hydrosilylation and the reaction of oxiranes with alcohols in any arbitrary sequence. A —(CH₂)₁₋₆-O— or a —(CH₂)₁₋₆-O'CH₂CHOH—CH₂O— residue is preferred. Z=—CH₂CH₂CH₂O is especially preferred, so that a Si-CH₂CH₂CH₂O bond results.

The alternately present group X is selected from —CO—, —COO—, and —CONR²—, in which R² s H or C₁-C₆ alkyl (the bonding to the polyalkylene oxide is performed so that no —O—O— or —O—N bond results).
a=0 to 2000,
b=0 to 2000,
c=0 to 100, and
a+b+c≧0,
d=0 or 1,
preferably, d and c=0.

Furthermore, a is preferably 1 to 100 and b is preferably 0 to 20.
R¹=H,
C₁-C₂₅ alkyl,
amino(C₁-C₂₅)alkyl,
(C₁-C₂₅)alkoxypoly(C₂-C₄)alkyleneoxy(C₁-C₂₅)alkyl,
hydroxypoly(C₂-C₄)alkyleneoxy(C₁-C₂₅)alkyl,
aminopoly(C₂-C₄)alkyleneoxy(C₁-C₂₅)alkyl,
C₆-C₁₀ aryl,
(C₆-C₁₀)aryl(C₂-C₆)alkyl, and
—(CH₂)ₙC₂F_{2z+}₁, in which n=1-12 and z=1-12,
one to three —CH₂ groups in the above-mentioned residues R able to be replaced by X, which, as defined above, is —O— or —NR³—, in which R³ is H or C₁-C₆ alkyl.

In this case, the indices a to c are the average degrees of polymerization resulting from the weight averages.

Preferably, R¹ =hydrogen, C₁-C₂₅ alkyl, particularly methyl. R¹ is especially preferably hydrogen.

The polyether polysiloxanes of the component d) used according to the present invention are expediently soluble in water at 25° C. or they are at least self-emulsifying in water. This means that a mixture made of water and the polyether polysiloxane, after mixing using a stirrer, forms a stable emulsion for more than 30 days, which is distinguished in that no phase separation is observable.

The solubility of the polyether polysiloxane d) used according to the present invention may be controlled in this case by the length of the polyether residue, the type of alkylene oxide units used, the siloxane chain length, and the ratio of diorgano siloxy units to polyether siloxy units, so that the desired solubility results. The ratio of diorgano siloxy units to polyether siloxy units is thus preferably not more than 10:1.

For the case in which polyethers having free OH groups are used, the molar proportion of these polyether polysiloxanes is preferably selected as smaller than the molar peroxide proportion in the cleaning composition.

The manufacture of the polyether polysiloxanes which are used according to the present invention as component d) is performed in a way known per se (e.g., U.S. Pat. No. 5,986,122, U.S. Pat. No. 4,857,583, EP 069338, EP 985698). It is performed, for example, through single-stage and/or multistage hydrosilylation of the corresponding hydrogen-functional siloxane with a suitable unsaturated precursor of the substituent to be introduced with the aid of a suitable homogeneous or heterogeneous transition metal catalyst.

Preferred precursors having one of the residues cited, which contains the polyalkylene oxide units onto which the polysiloxanes are added, have a terminal C=C double bond.

Allyl polyethers having the following structure (V) or (VI) are especially preferred:

H₂C=CH—CH₂—O—(CH₂CH₂O)ₐ(CH₂CH{CH₃}O)_{b}(CH₂CH₂CH₂CH₂O)_{c}X_{d}—R¹ (V)

These allyl polyethers may be produced in a way known per se from allyl alcohol and oxiranes, particularly ethylene oxide, propylene oxide, and/or butylene oxide. The indices a, b, and c cited above are controlled through the selection of appropriate molar ratios. Furthermore, different block polyalkylene oxide residues or statistically distributed polyalkylene oxide residues may be produced in a way known per se through the selected sequence of the oxiranes.

Alternatively, the polyether groups on the polysiloxanes may be manufactured via hydrosilylation of the corresponding hydrogen-functional siloxane using unsaturated epoxides, such as allyl glycide ether, vinyl cyclohexene oxide, or allyl glycosides and subsequent ring opening of the epoxide ring using a polyether having reactive hydrogen.

H₂C=CH—CH₂—O—CH₂CHOH—CH₂O—(CH₂CH₂O)a(CH₂CH {CH₃}O)_{b}-(CH₂CH₂CH₂CH₂O)_{c}X_{d}-R¹ (VI)

Suitable transition metal catalysts for the hydrosilylation are generally known. Examples cited here are transition metal complexes of platinum, palladium, ruthenium, and rhodium, as well as colloidal forms of these transition metal complexes. Transition metal complexes of platinum in the oxidation stages (0), (II), and (IV) and colloidal platinum metal are preferred. The Speier catalyst (hexachloroplatinic acid in isopropanol and/or alcohol) and complexes of platinum with tetramethyl divinyl disiloxane (Karstedt catalyst) are especially preferred.

Especially pronounced stabilization is achieved in the peroxide compound contained in the composition if the polyether polysiloxane obtained above is subjected to an additional purification step. This purification step is particularly used for separating the metal catalysts and other impurities, which remain from the addition reaction (hydrosilylation) of hydrogen siloxanes/silanes with alkenyl polyethers, from the resulting polyether polysiloxane. It has been found that the speed of decomposition of peroxide oxygen is particularly influenced by the metal content, i.e., typically the platinum content, and the content of other, often colored compounds in the polyether polysiloxane. A suitable purification is particularly achieved if adsorption means are used, which allow both the metal content of the transition and/or heavy metals to be reduced and simultaneously allow further colored and/or turbid compounds which catalyze decomposition, catalysts, or other impurities to be separated from the polyether polysiloxanes. An essential purification step relates to the separation of metal compounds, which were used for the addition of alkenyl polyethers to hydrogen siloxanes during the manufacturing of polyether polysiloxanes, and the catalyst supports.

Methods for fixing, removing, and/or reclaiming platinum and/or rhodium catalysts are known in the literature. EP 546 716 discloses a fixed platinum catalyst on a support. U.S. Pat. No. 5,536,860 cites further examples of fixed rhodium catalysts for hydrosilylation. Similar catalysts are found in U.S. Pat. No. 5,187,134. U.S. Pat. No. 5,237,019 discloses fixed hydrosilylation catalysts having amino alkyl groups as complexing groups, which are to prevent transfer of the metal into the solution of the reaction product. U.S. Pat. No. 4,156,689 teaches the purification of chlorosilanes before hydrosilylation, and U.S. Pat. No. 5,986,122 teaches the removal of peroxides by adding acid before hydrosilylation. However, there is no indication here how metals and other impurities are to be separated after the hydrosilylation in order to minimize the peroxide decomposition. U.S. Pat. No. 4,935,550 claims the extraction of rhodium using polar and non-polar solvents and phosphorus-containing complex formers. U.S. Pat. No. 5,342,526 cites an extraction agent for removing platinum or palladium from reaction solutions. U.S. Pat. No. 4,900,520 describes the separation of platinum from polyether polysiloxanes using basic ion exchange resins.

The inventors of the present invention found a novel preferred method for purifying polyether polysiloxanes which is especially advantageous. The present invention therefore also relates to a method for purifying polyether polysiloxanes through treatment with activated carbon and the use of the polyether polysiloxanes thus purified in cleaning compositions, particularly those which contain peroxide compound.

The polyether polysiloxanes manufactured through hydrosilylation reaction are preferably treated by stirring with selected activated carbons or a mixture made of activated carbon and water or a mixture made of activated carbon and alcohol and subsequent filtration in order to remove the impurities which encourage decomposition. The temperatures applied in this case are between 0° and 150° C.

This method is especially suitable for separating all hydrosilylation catalysts, i.e., soluble hydrosilylation catalysts, such as the complexes of platinum in general, such as the Speier catalyst (hexachloroplatinic acid in isopropanol and/or alcohol), complexes of platinum with tetramethyldivinyldisiloxane (Karstedt catalyst), and platinum catalysts on diverse supports, as are described in the related art above. To separate the catalysts and impurities which encourage peroxide decomposition, the corresponding polyether polysiloxane is admixed with 0.1-5 weight-percent activated carbon, 0-60 weight-percent solvent, such as ethanol or isopropanol, and 0-5 weight-percent water. This mixture is then stirred for 1 hour at 20-150° C., preferably at 70-100° C. The solvent is then removed under vacuum by evaporation at this point in time or possibly, if the viscosity of the polyetber polysiloxane is too high, later after the filtration. Subsequently, this dispersion is cooled, admixed with 0-5 weight-percent filtering aid (e.g., diatomaceous earth, silicates, inorganic oxides, porous adsorbents, such as silicate gels, activated carbon, porous resins, cellulose powders, or cellulose fabrics) and filtered via a depth filter of Seitz type EK or EKS. The solvent is now removed under vacuum through evaporation, if it was not already removed before filtering. In a polyether polysiloxane mixture which contains 5 to 10 ppm platinum of a hydrosilylation catalyst, using one single adsorption and filtration step, a remaining platinum content of 0.2 to 1.5 ppm platinum may be achieved as a function of the type and quantity of the activated carbon.

The platinum is determined using ICP-MS (inductive coupled plasma mass spectrometry—detection limit platinum:0.003 ppm). Nearly all types of activated carbon (Norit, Jacobi, Chemviron) having BET surfaces of 100-2000 m²/g, pH values of 1-10, and particle diameters of 5-1000 μm or coarser granulates may be used. However, BET surfaces of 800-2000 m²/g, pH values of 2-8 and particle diameters of 35-100 μm are preferred.

When selecting the activated carbon, a compromise must be made between adsorption performance and quantity of activated carbon added, so that the goal of lower metal content and lower color index, i.e., large quantities of activated carbon and therefore high viscosity, may be achieved optimally with the least possible method complexity, i.e., using one filtration step.

Simultaneously, impurities which cause coloration and/or turbidity and encourage peroxide decomposition are reduced with the aid of this purification method. These additional impurities are analyzed using, for example, a color index measurement via a photometer, according to Dr. Lange of Cologne, using a device of the type Lico 200/300 in 50 mm rectangular cuvettes. The result is shown according to the CIE system as either L*, a*, b* value, iodine or Hazen color index. In this case, the iodine color index is preferred for analysis.

The polyether polysiloxanes used according to the present invention, particularly after they are manufactured according to the method described above or purified after the hydrosilylation, preferably have a content of the above-mentioned hydrosilylation catalysts, particularly a platinum content of at most 10 ppm, preferably at most 5 ppm, especially preferably at most 1.2 ppm, and even more preferably at most 1 ppm.

The iodine color index is between 0 and 5, preferably between 0.1 and 1. The platinum content in the cleaning composition is thus below 0.75 ppm platinum, preferably below 0.08, especially preferably below 0.003 ppm platinum.

Alternatively, the hydrosilylation reaction may also be performed in the presence of those catalysts which may be separated from the polyether polysiloxanes after the reaction as much as possible through simple separation. Such transition metal catalysts are, for example, those which are applied to a solid support material which is insoluble in the reaction mixture. They may subsequently be separated, through simple filtration or decanting, down to a residual content of transition metal of less than 1 ppm. Examples of catalysts of this type are transition metals such as platinum, rhodium, and palladium which are applied to support materials such as silica gel, aluminum oxide, titanium dioxide, activated carbon, or further mineral materials.

This method only provides advantages if no further fine filtration is necessary because of the type of the catalyst support. This method is therefore preferred if the filtration does not require extremely fine filtration, as is necessary for the separation of many activated carbons, due to a suitable catalyst support or a subsequently added adsorption or complexing agent.

The manufacture of the compositions according to the present invention is expediently performed by mixing the components a) through d) and possibly the components e) and f). The polyether polysiloxane used has preferably previously been subjected to the purification treatment using activated carbon. In an especially preferred variation for manufacturing the composition according to the present invention, first the component a), a partial quantity of c), b), and d), and possibly the components e) and i) are mixed with one another and subsequently the remaining component c) is admixed. The quantity of the component c) is preferably selected so that a pH value from 0 to 7 results.

A preferred composition according to the present invention is obtained by mixing
a) water,
at least one peroxide compound b), in a quantity which results in 0.001-10 weight-percent peroxide oxygen in the composition,
at least one acid c), in a quantity which results in a pH value of the composition of 0 to 7, preferably 0 to 5,
0.01-7.5 weight-percent, preferably 0.05-5 weight-percent, of at least one polyether polysiloxane d),
0-7.5 weight-percent, preferably 0.05-5 weight-percent, of at least one low molecular weight siloxane e),
0-20 weight-percent, preferably 0-15 weight-percent, of at least one auxiliary material f),
   the weight specifications each relating to the total quantity of the composition.

The composition according to the present invention may alternately contain, as the component e), a low molecular weight siloxane, such as cyclic, branched, or linear polyorganosiloxane having a molecular weight expediently below 1000 Dalton. Cyclic siloxanes, such as octamethylcyclotetrasiloxane, decamethyl-cyclopentasiloxane, and linear siloxanes such as decamethyltetrasiloxane, pentamethylalkyldisiloxane, and heptamethylalkyltrisiloxane are preferred. Cyclic and linear siloxanes having a boiling point below 230° C. are preferred.

The use of these low molecular weight siloxanes serves to prevent further adhesion of dirt and for the care of the surface.

Furthermore, the compositions according to the present invention possibly contain at least one auxiliary material f). These are particularly typical components of commercially available cleaners, such as aromatics, surfactants, solvents, such as alcohols, solubilizers, sequestering agents (Ullmann's Encyclopedia of Industrial Chemistry, 6th edition 2002, Electron Rel.), pigments, preservatives, biocides, and thickeners. A comprehensive list of possible components may be found, for example, in the yearbook for practitioners (from the oil, fats, soaps, body care products, wax, and other chemical engineering industries), 22nd edition, 1979. Aromatics, surfactants, sequestering agents, and thickeners are preferred.

The use of alcohols or solvents as the component f) is advantageous, for example, if difficult cleaning problems are to be solved or the rapid evaporation of the component f) is desired. The alcohol or the solvents must be free of materials which decompose peroxides. The molar proportion of the alcohol is preferably not to exceed that of the peroxide.

Alcohols include straight-chain, branched, and/or cyclic alcohols having up to eight carbon atoms. Cyclic alcohols particularly include those having 5 or 6 carbon atoms. Straight-chain monoalcohols, such as ethanol and propanol, are preferred.

Water-alcohol mixtures may thus also be used according to the present invention.

The compositions according to the present invention are especially suitable for cleaning, caring, and/or disinfecting treatment of substrate surfaces, such as the surfaces of mineral, metallic, duroplastic, or thermoplastic substrates, such as ceramic, tiles, glass, plastics, enameled surfaces, metals, and floor coverings. The compositions according to the present invention are especially preferably used as cleaning compositions. Using them, it is possible to reduce the adhesion of dirt particles to a treated surface, to improve the runoff of water, contaminated water, and other aqueous solutions from treated surfaces, to reduce the formation of residues such as lime, lime soaps, urine deposits, and sewage residues on the treated surface, and to disinfect the surfaces thus treated.

### EXAMPLES

### Example 1

### Manufacture of a Polyether Polysiloxane via Hydrosilylation

1483.8 g allyl polyether H₂C=CH—CH₂—O—(CH₂CH₂O)₁₁CH₂-CH₂OH was dissolved in 314 g isopropanol under nitrogen gas and heated to 80-95° C. under reflux. While heated, first 89 mg platinum catalyst solution (12% platinum, corresponding to 4.3 ppm platinum of the mixture) of a Pt⁰-divinyl tetramethyl disiloxane complex was added and subsequently 612.7 g of a polymer SiH polymer of the composition Me₃SiO(Me₂SiO)₁₅(MeHSiO)₅SiMe₃ (M-D₁₅-D^{H}₅-M) was dosed in.

This polymer had a content of 3.2 mmol/g SiH. The hydrosilylation reaction could be recognized through temperature increase and elevated reflux. After three hours at 82-95° C., the solvent was removed through distillation.

A colored polyether polysiloxane in 98% reaction of SiH, according to residual SiH content of an alkaline volumetric titration, was obtained. The platinum content of the filtrate was 5.1 ppm, the iodine color index was 6.5.

### Example 2

Manufacture of a Polyether Polysiloxane Having a Low Platinum Content

1483.8 g allyl polyether H₂C=CH—CH₂—O—(CH₂CH₂O)₁₁CH₂—CH₂OH was dissolved in 314 g isopropanol under nitrogen gas and heated to 80-95 ° C. under reflux. While heated, first 52 mg platinum catalyst solution (12% platinum, corresponding to 2.6 ppm platinum of the mixture) of a Pt⁰-divinyl tetramethyl disiloxane complex was added and subsequently 612.7 g of a polymer SiH polymer of the composition Me₃SiO(Me₂SiO)₁₅(MeHSiO)₅SiMe₃ (M-D₁₅-D^{H}₅-M) was dosed in.

This polymer had a content of 3.2 mmol/g SiH. The hydrosilylation reaction could be recognized through temperature increase and elevated reflux. After three hours at 82-95 ° C., the solvent was removed through distillation. A colored polyether polysiloxane in 98% reaction of SiH, according to residual SiH content of an alkaline volumetric titration, was obtained. The platinum content of the filtrate was 3 ppm, the iodine color index was 4.

### Example 3

### Purification of a Polyether Polysiloxane

75 g of the polyether polysiloxane from Example 1 was admixed with 25 g isopropanol having approximately 0.2 weight-parts activated carbon Norit of type CA 1 (BET surface=1400 m²/g, pH=2, d50%=41 μm) and approximately 1 weight-part water. This mixture was then stirred for 1 hour at 82-85° C. under N₂ atmosphere with reflux. Subsequently, the isopropanol and low boiling point polyether components were evaporated in vacuum and the mixture was cooled to 25 ° C. The remaining polyether polysiloxane was admixed with 0.2 weight-parts of a filtering aid (diatomaceous earth Dicalite WF) and filtered via a depth filter Seitz type EKS. A clear colorless liquid having an iodine color index of 1 and a platinum content according to ICP-MS of 1.2 ppm was obtained.

### Example 4

### Purification of a Polyether Polysiloxane

75 g of the polyether polysiloxane from Example 1 was admixed with 25 g isopropanol having one weight-part activated carbon Norit of type CA 1 (BET surface=1400 m²/g, pH=2, d50%=41 μm) and approximately 1 weight-part water. This mixture was then stirred for 1 hour at 82-85° C. under N₂ atmosphere with reflux. Subsequently, the isopropanol and low boiling point polyether components were evaporated in vacuum and the mixture was cooled to 25° C. The remaining polyether polysiloxane was admixed with one weight-part of a filtering aid (diatomaceous earth Dicalite WF) and filtered via a depth filter Seitz type EKS. A clear colorless liquid having an iodine color index of 0.2 and a platinum content according to ICP-MS of 0.24 ppm was obtained.

### Example 5

### Evaluation of the Storage Stabilities at 25 and 50° C.

96 g 0.1 m sulfuric acid, 1 g hydrogen peroxide solution (approximately 35%), and 3 g of the polyether polysiloxanes obtained in Examples 1 through 4 (M-D₁₅-D^{R}₅-M with R=—(CH₂)₃O(CH₂CH₂O)₁₁CH₂-CH₂OH) were mixed with one another to produce a cleaning composition in such a way that for this purpose the polyether polysiloxanes from Examples 3 through 4 having different platinum contents and low iodine color index and/or those from Example 1 and 2 having increased platinum content and increased color index were used. The influence of the platinum content and the color index on the storage of the cleaning composition is shown at 25° C. in Table 1 and at 50 ° C. in Table 2. For this purpose, the remaining content of peroxide (active) oxygen is measured (photometric absorption at 508 nm of the iron (III) thiocyanate formed).

To determine the storage stability under enhanced conditions, the samples were covered with a watch glass, but not sealed gas-tight, stored at a temperature of 50° C. in a dry cabinet, and assayed at regular intervals for the content of peroxide active oxygen. The results are shown in Tables 1 and 2.

### Comparative Experiment VI

96 g 0.1 m sulfuric acid and 1 g hydrogen peroxide solution (approximately 35%) was mixed into a cleaning composition without adding a polyether polysiloxane and the decomposition of the peroxide oxygen was evaluated over the duration of storage at 25 ° C. and 50 ° C.—see Tables 1 and 2. The platinum content of this cleaning composition was below 0.03 ppm.

TABLE 1
active oxygen with storage at 25° C.

| | Example | | | | |
|---|---|---|---|---|---|
| | V1 | 4 | 3 | 2 | 1 |
| [Days] | [ppm] O | [ppm] O | [ppm] O | [ppm] O | [ppm] O |
| 0 | 1654 | 1711 | n.b. | 1629 | 1600 |
| 7 | 1565 | 1724 | n.b. | 1519 | 1526 |
| 15 | 1508 | 1708 | n.b. | 1483 | 1479 |
| 19 | 1513 | 1795 | n.b. | 1544 | 1532 |
| 21 | 1493 | 1751 | n.b. | 1513 | 1503 |
| 28 | 1422 | 1743 | n.b. | 1491 | 1502 |

n.b. = not measured

Table 1 shows that the peroxide oxygen in the cleaning composition which also contains a polyether polysiloxane is decomposed more slowly than that in comparative experiment VI without a polyether polysiloxane.

Table 2 shows the storage stability for enhanced and/or time-lapse storage, in which the temperature is increased to 50° C.

Table 2 shows in this case that the decomposition is slowed with increasing purity of the polyether polysiloxane.

It is particularly to be noted that the sample having a platinum content of 0.24 ppm platinum and low color index has no detectable degradation of hydrogen peroxide at 25° C.

TABLE 2
active peroxide oxygen in [ppm] with storage at 50° C.

| | Example | | | | |
|---|---|---|---|---|---|
| | V1 | 4 | 3 | 2 | 1 |
| [Days] | [ppm] O | [ppm] O | [ppm] O | [ppm] O | [ppm] O |
| 0 | 1627 | 1734 | 1466 | 1664 | 1664 |
| 6 | 1105 | 1632 | 1217 | 1387 | 1454 |
| 16 | 651 | 1376 | 1065 | 989 | 948 |
| 20 | 510 | 1332 | 1034 | 918 | 936 |
| 29 | 304 | 1136 | 906 | 689 | 734 |

1. A composition, formed by mixing:
a) water,
b) at least one peroxide compound,
c) at least one acid,
d) at least one organopolysiloxane having at least one alkyl group, said at least one alkyl group having at least one ether group or at least one OH group or having at least one ether group and at least one OH group,
e) optionally at least one siloxane having a lower molecular weight than said organopolysiloxane, and
f) optionally at least one auxiliary material.

2. The composition according to claim 1, wherein said at least one organopolysiloxane d) is selected from the group consisting of organopolysiloxanes of the formulae (I), (II), and (III): 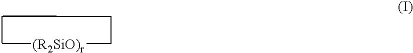
R₃SiO(R₂SiO)ₓSiR₃ (II)
[(R₃SiO_{½})₁₋₄(SiO _{4/2})]_{y} (III)
in which
r=3-10 and
x=0-200,
y=1-1000,
the substituents R being identical or different and selected from the group consisting of:
straight-chain and branched C₁-C₁₂ alkyl, C₆-C₁₄ cycloalkyl, phenyl, phenyl ethyl, —(CH₂)ₙC_{z}F_{2z+1}, in which n=1-12 and z=1-12, and alkyl groups containing at least one ether group and/or at least one OH group,
with the proviso that at least one substituent R per polysiloxane molecule represents said alkyl group containing at least one ether group and/or at least one OH group.

3. The composition according to claim 1, wherein said alkyl group containing at least one ether group and/or at least one OH group, has a substituent R of the formula (IV):
—Z—(CH₂CH₂O)ₐ(CH₂CH{CH₃}O)_{b}(CH₂CH₂CH₂CH₂O)_{c}X_{d}-R¹ (IV)
in which:
Z is a straight-chain or branched alkyl or cycloalkyl residue, which may be interrupted by —O— and/or —CO— and is optionally substituted by at least one OH group,
X=—CO—, —COO—, —CONR²—, in which R² is H or C₁-C₆ alkyl,
a=0 to 2000,
b=0 to 2000,
c=0 to 100, and
a+b+c≧0,
d=0 or 1, and
R¹=
H,
C₁-C₂₅ alkyl,
amino(C₁-C₂₅)alkyl,
(C₁-C₂₅)alkoxypoly(C₂-C₄)alkyleneoxy(C₁-C₂₅)alkyl,
hydroxypoly(C2-C₄)alkyleneoxy(C₁-C₂₅)alkyl,
aminopoly(C₂-C₄)alkyleneoxy(C₁-C₂₅)alkyl,
C₆-C₁₀ aryl,
(C₆-C₁₀)aryl(C₂-C₆)alkyl, or
—(CH₂)ₙC_{z}F_{2z+1}, in which n=1-12 and z=1-12, one to three —CH₂ groups in the substituent R optionally being replaced by X, as defined above, or by —O— or —NR³—, in which R³ is H or C₁-C₆ alkyl.

4. The composition according to claim 1, wherein the peroxide compound b) is hydrogen peroxide.

5. The composition according to claim 1, obtainable by mixing
water a),
at least one peroxide compound b), in a quantity which results in 0.001-10 weight-percent peroxide oxygen in the composition,
at least one acid c), in a quantity which results in a pH value of the composition of 0 to 7,
0.01-7.5 weight-percent of at least one organopolysiloxane d),
0-7.5 weight-percent of at least one low molecular weight siloxane e),
0-4.1 weight-percent of at least one auxiliary material f), said weight-percent amounts relating to the total quantity of the composition.

6. The composition according to claim 1, wherein, at 25° C., the organopolysiloxane d) is soluble in water or is self-emulsifying in water.

7. A method for manufacturing the composition of claim 1, which comprises mixing components a) through d) and optionally components e) and f).

8. A method for manufacturing the composition of claim 1, wherein the component a), a partial quantity of c), b), and d), and possibly the components e) and f) are mixed with one another and subsequently the remaining partial quantity of the component c) is admixed.

9. The method according to claim 7, further comprising the treatment of the organopolysiloxane(s) d) with activated carbon, prior to addition of said organopolysiloxane(s) to said mixture.

10. The method according to claim 7, wherein the quantity of component c) is an amount which provides a pH value of the mixture of from 0 to 7.

11. A method for purifying organopolysiloxenes having at least one alkyl group, the alkyl group containing at least one ether group and/or at least one OH group, which comprises treating said organopolysiloxanes with activated carbon.

12. A cleaning composition comprising an organopolysiloxane purified by the method of claim 11, in cleaning compositions.

13. A method of cleaning, maintaining, disinfecting or cleaning and disinfecting substrate surfaces, which comprises applying a composition of claim 1 to said surfaces.

14. A cleaning composition comprising the composition of claim 1.

15. The method according to claim 8, further comprising the treatment of the organopolysiloxane(s) d) with activated carbon, prior to addition of said organopolysiloxane(s) to said mixture.

16. The method according to claim 8, wherein the quantity of component c) is an amount which provides a pH value of the mixture of from 0 to 7.
